(19) United States
(12) Patent Application Publication
(10) Pub. No.: US 2008/0048402 A1
(43) Pub. Date: Feb. 28, 2008

(54) Metallic Cylinder Head Gasket

(76) Inventors: Albrecht Sailer, Neu-Ulm (DE); Jurgen Schneider, Merklingen (DE); Bernd Raess, Vohringen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/588,880

(22) PCT Filed: Feb. 10, 2005
(86) PCT No.: PCT/EP05/01348

§ 371 Date: May 14, 2007

(30) Foreign Application Priority Data
Feb. 10, 2004 (DE) 10 2004 006 483.0

(51) Int. Cl. F16J 15/08

(52) U.S. Cl. 277/627

(57) ABSTRACT

The invention relates to a metallic flat gasket having at least one through-opening comprising at least two metallic layers (1, 4) made of spring steel, there being disposed, in the layer (1), at least one stopper (11) which surrounds the through-opening and a bead (12) which is assigned to the stopper (11) and, in the at least one layer (4), a bead (12).

In the at least one layer (4), outwith the stopper region or between the stopper region and the bead (12), at least one cranking (13) is configured adjacent to the bead (12).

The invention relates to a metallic flat gasket comprising at least two metallic layers made of spring steel, at least one layer having a stopper which surrounds the at least one through-opening and a bead assigned to the stopper and at least one second layer having a bead and, adjacent to the bead, a cranking. The invention likewise relates to a metallic flat gasket comprising at least three metallic layers, at least two layers being formed from spring steel and there being disposed, in an inner layer, at least one stopper which surrounds the at least one through-opening and, in the two layers adjacent to this inner layer, respectively one bead which is assigned to the at least one stopper and the two layers adjacent to the inner layer having respectively one cranking adjacent to the bead.

The metallic flat gaskets are in particular cylinder head gaskets but can also be gaskets in the intake, exhaust or turbo-charger region. The metallic flat gaskets thereby serve in particular for sealing combustion chamber passages or flanges. In the following, sealing regions of this type are termed through-openings.

It is known with metallic flat gaskets to dispose a stopper adjacent to the bead. The object of the stopper, also termed deformation limiter, resides in preventing complete compression of the bead so that the sealing effect caused by the bead is not impaired. Normally flat gaskets of this type comprise a plurality of metallic layers. In the state of the art, laminates of metallic flat gaskets are thereby known, said laminates comprising a plurality of metallic gasket layers, in particular made of spring steel, and in which another spacer layer can be disposed between the metallic layers which needs not comprise spring steel.

For flat gaskets comprising at least two metallic layers made of spring steel, in which a bead and a stopper are disposed in one layer, the problem exists however that as a result no symmetrical distribution of the stopper height over all the layers is effected. The beads are situated here in different compression states, which causes undesired tensions and, in the worst case, can lead to the formation of cracks. Solutions with at least two stopper layers which would lead to a symmetrical distribution of the stopper height are very complex in the production thereof and above all very expensive so that, from an economic point of view, they do not represent a solution.

It is therefore the object of the present invention to propose a metallic flat gasket in which a symmetrical distribution of the stopper height over the individual layers is effected and which is simultaneously economical in the production thereof.

The object of the present invention is achieved by the features of patent claims 1 and 2. The sub-claims reveal advantageous developments.

It is proposed according to the invention, in metallic flat gaskets which comprise at least two layers made of spring steel, that in at least one of these layers at least on one side a cranking is configured additionally adjacent to the bead. By introducing this cranking in the spring steel layer, a symmetrical distribution of the stopper height to each layer is now achieved. In order to achieve optimum dimensional uniformity in the installed state, it is thereby favourable if, in the uninstalled state, the offset of the layer formed by the cranking is smaller than the average constructional height of the beads.

In a development of the metallic flat gasket according to the invention, this comprises at least three metallic layers, an inner, preferably the central, layer having a stopper which surrounds the through-opening and a bead being assigned to the stopper. Half-beads, but preferably full beads, are hereby used. At least two of the at least three metallic layers comprise spring steel, the choice of material of the stopper layer depends upon the choice of stopper element.

The cranking is always situated outwith the stopper region of the adjacent layers or between stopper region of the adjacent layers and bead.

The flat gasket according to the invention can of course be developed in such a manner that even more than two layers are present as gasket layers made of spring steel. Thus the metallic flat gasket can have at least one further layer made of spring steel or also, as already known per se from the state of the art, in addition other spacer layers which do not comprise spring steel.

It is essential in the metallic flat gasket according to the invention that at least two layers made of spring steel are present, there being disposed, in one layer, a bead and at least one cranking assigned to the bead and, in the second layer made of spring steel, a bead and a stopper. In the case of more than two layers, bead and stopper can be distributed over two layers; the layer which contains only the stopper need not be formed from spring steel.

In the case of the metallic flat gasket according to the invention, a stopper can be used which is formed by a separate ring, a separate annular disc or by relizing an undulating, saw-tooth or trapezoidal shape in the metallic layer. In particular the last-mentioned embodiment is hereby preferred, i.e. the one in which the stopper is configured in an undulating, saw-tooth or trapezoidal shape. When using a separate ring or a separate annular disc as stopper, the latter can in addition be situated on the lower side of an offset step in the stopper layer.

If the stopper is situated in a layer without a bead, then it is possible to form the stopper by crimping over or swaging this metallic layer which is not made of spring steel.

In a gasket with an even number of layers with a bead, the constructional height of the at least one cranking corresponds approximately to half the height of the stopper, in a gasket with an odd number of layers with a bead, approximately to one-third of the height of the stopper.

Of course the combination of the profilings bead, stopper and cranking, can be used not only for sealing through-openings but also for sealing the backland of metallic flat gaskets, e.g. for the outer edge and also for fluid and screw holes. In addition to full beads, also half-beads can be used here, too. In the case of simultaneous use in through-openings and in the backland, the respective profilings can be configured differently in the different usage regions.

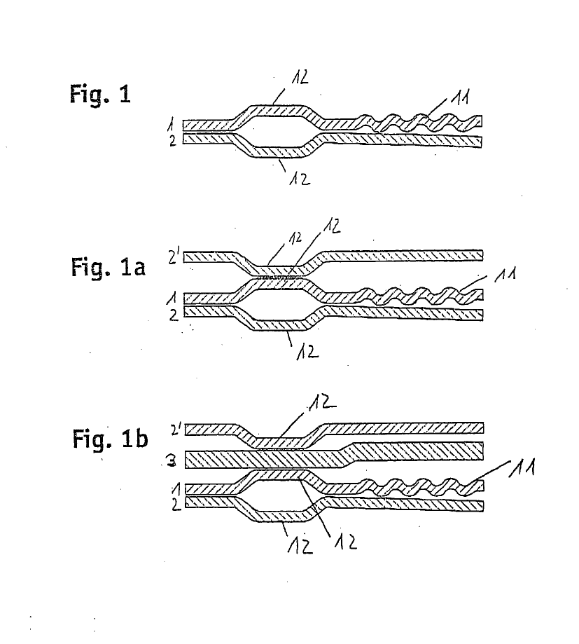

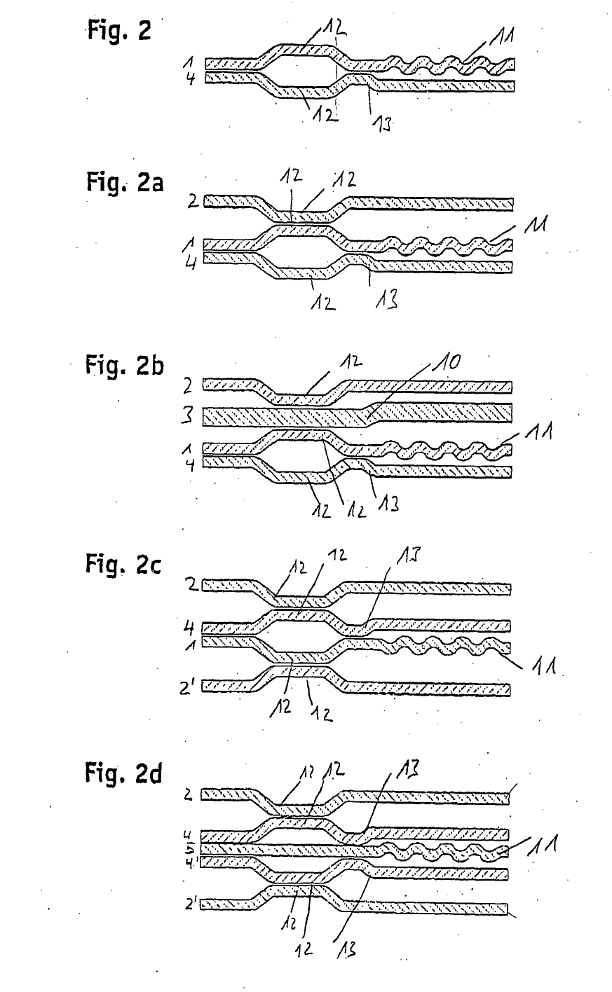

The invention is explained subsequently in more detail with reference to FIGS. 1 and 2.

FIGS. 1, 1a and 1b show three different constructions of metallic flat gaskets of the state of the art,

FIGS. 2 to 2d show five different solutions of metallic flat gaskets according to the invention.

The same reference numbers are used throughout for equivalent functions.

In FIG. 1 a schematic cross-section through a metallic flat gasket is illustrated, said flat gasket comprising the two spring steel layers (1, 2). The spring steel layer 1 thereby has a full bead 12 and a stopper 11 in the form of an undulation. The layer 2 contains only one full bead 12.

In FIG. 1a, a schematic cross-section through a metallic flat gasket is illustrated, said flat gasket comprising three metallic layers made of spring steel (2, 1, 2′). The central layer 1 has a stopper 11 in the form of an undulation and a full bead 12. The layers 2 and 2′ likewise have full beads 12 stacked onto the full bead 12 of layer 1.

In FIG. 1b, an analogous construction is shown, in which merely one spacer sheet 3 with an offset step 10 is still present. Despite the offset step 10 in the spacer sheet 3, no symmetrical distribution of the stopper height takes place here; the bead in the layer 2 is not optimally stopped.

As a result of the fact that with these flat gasket embodiments of the state of the art only one stopper element 11 is now disposed in a layer 1 made of spring steel, the result is no symmetrical distribution of the stopper height over the individual layers 1, 2 or 1, 2, 2′ or 1, 2, 2′ and 3. In these constructions, the beads are therefore situated in different operating regions, which results in undesired tensions and in the worst case can lead to the formation of cracks.

FIG. 2 shows an embodiment according to the invention of the metallic flat gasket. The construction of the metallic flat gasket according to FIG. 2 corresponds to that described already in FIG. 1. The metallic flat gasket according to FIG. 2 hence comprises two layers made of spring steel 1 and 4. In the metallic flat gasket according to FIG. 2, the stopper 11 is also introduced in the form of an undulation into a gasket sheet made of spring steel. The metallic flat gasket according to the invention according to the embodiment of FIG. 2 is characterised in that, adjacent to the bead 12 in the layer 4, a cranking 13 is introduced into the metal sheet made of spring steel. As a result, dimensional uniformity of the stopper height over the individual gasket sheets made of spring steel 1 and 4 is achieved.

In FIG. 2a a further embodiment is represented which corresponds essentially to that of FIG. 2 but this embodiment has also in addition a bead layer 2.

In FIG. 2b, a further embodiment is illustrated which corresponds essentially to that of FIG. 2a but this embodiment has also in addition a spacer sheet 3 with an offset step 10. Due to the cranking 13, a uniform distribution of the stopper heights is achieved.

In the embodiment according to FIG. 2c, the metallic flat gasket is constructed from four metallic layers made of spring steel 2, 4, 1 and 2′. Analogously to FIGS. 1, 1a and 1b, one stopper 11 is assigned to one bead 12 in the metallic layer 1. In the embodiment according to FIG. 2c the metallic layer 4 made of spring steel is now arranged above the metallic layer 1 and in turn has a cranking 13 according to the invention. The packet comprising layers 1 and 4 is thereby encompassed by the metallic layers 2 and 2′ which again have respectively beads. These embodiments according to FIG. 2c are also now characterised in that a uniform distribution of the stopper height over the individual layers is effected.

In FIG. 2d, a further embodiment is shown which comprises in total five layers. Here the stopper layer 5 is configured without a bead and is encompassed by bead layers 4 and 4′ which respectively have a cranking 13 according to the invention. In addition, the symmetrical construction of the gasket has two bead layers 2 and 2′. In this embodiment also, uniform distribution of the stopper height over the individual layers is effected.

1-12. (canceled)

13. A metallic flat gasket comprising:
at least one through-opening;
at least two layers constructed from a spring steel;
at least one stopper which surrounds said through-opening, said at least one stopper disposed in a first layer;
a first bead which is adjacent said stopper, said first bead disposed in said first layer;
a second bead disposed in a second layer; and
at least one cranking disposed in said second layer adjacent said second bead and between said stopper and said first bead in said first layer;
wherein the constructional height of said at least one cranking corresponds approximately to a value 1/(2n+2) times the height of said stopper;
wherein n is the non-integer part of said value which is the number of said layers that have a bead divided by 2.

14. The gasket of claim 13, wherein said cranking of said second layer is smaller than the average constructional height of said first bead and said second bead when said gasket is in a non-compressed state.

15. The gasket of claim 13, wherein said beads are such that one of said beads is disposed above the other of said beads.

16. The gasket of claim 13, wherein said gasket further includes a third layer constructed from a spring steel in which a third bead is disposed.

17. The gasket of claim 13, wherein said gasket further includes a layer in the form of a spacer sheet.

18. The gasket of claim 13, wherein said stopper is formed by crimping over or swaging.

19. The gasket of claim 13, wherein said stopper is formed by one of a separate ring, a separate annular disk or an undulating, saw-tooth shape or an undulating trapezoidal shape.

20. The gasket of claim 13, wherein said height of said stopper is between about 0.04 mm and about 0.25 mm.

21. The gasket of claim 13, wherein said gasket is a cylinder head gasket.

22. The gasket of claim 13, wherein said gasket is located in one of an intake region, an exhaust region, or a turbo-charger region of an engine.

23. A flat gasket comprising:
at least one through-opening;
at least three layers, including at least two layers constructed from a spring steel;
an inner layer adjacent to said two layers, said inner layer including at least one stopper which surrounds said through-opening;
one bead disposed in each of said two layers; and
at least one cranking disposed in at least one of said two layers adjacent said inner layer between said stopper region and said beads;
wherein the constructional height of said at least one cranking corresponds approximately to a value 1/(2n+2) times the height of said at least one stopper;
wherein n is the non-integer part of said value produced when the number of gasket layers which have said beads is divided by 2.

24. The gasket of claim 23, wherein said cranking is smaller than the average constructional height of said beads when said gasket is in a non-compressed state.

25. The gasket of claim 23, wherein said gasket further including a layer constructed from a spring steel in which another bead is disposed.

26. The gasket of claim 23, wherein said gasket further includes a layer in the form of a spacer sheet.

27. The gasket of claim 23, wherein said beads are such that one of said beads is disposed above the other of said beads.

28. The gasket of claim 23, wherein said stopper is formed by one of a separate ring, a separate annular disk, or an undulating, saw-tooth shape or an undulating trapezoidal shape.

29. The gasket of claim 23, wherein said stopper is formed by crimping over or swaging.

30. The gasket of claim 23, wherein said height of said stopper is between about 0.04 mm and about 0.25 mm.

31. The gasket of claim 23, wherein said gasket is a cylinder head gasket.

32. The gasket of claim 23, wherein said gasket is located in one of an intake region, an exhaust region or a turbo-charger region of an engine.
